(19) United States
(12) Patent Application Publication
(10) Pub. No.: US 2025/0023998 A1
(43) Pub. Date: Jan. 16, 2025

(54) COMPUTER-READABLE STORAGE MEDIUM, INFORMATION PROCESSING DEVICE, AND METHOD TO IMPROVE PROCEDURE TO ACCESS SERVICE PROVIDING SERVER

(71) Applicant: BROTHER KOGYO KABUSHIKI KAISHA, Nagoya (JP)

(72) Inventors: Kenju NARITA, Nagoya (JP); Yoshito HOSOMIZO, Konan (JP)

(21) Appl. No.: 18/901,103

(22) Filed: Sep. 30, 2024

Related U.S. Application Data
(63) Continuation of application No. PCT/JP2023/011794, filed on Mar. 24, 2023.

(30) Foreign Application Priority Data
Mar. 30, 2022 (JP) 2022-055385

(51) Int. Cl. H04N 1/34; G06F 3/12

(52) U.S. Cl. CPC H04N 1/344; G06F 3/1222; G06F 3/1236; G06F 3/1238; H04N 1/346

(57) ABSTRACT

A non-transitory computer-readable storage medium stores computer-readable instructions that are executable by a computer of an information processing device and compatible with a printer. The instructions realize a support program supporting a general-purpose print program incorporated in advance in an operating system of the information processing device and is configured to, when executed by the computer, cause the information processing device to, in response to receiving a request for processing from the general-purpose print program when the operating system has accepted an activation instruction to activate the instructions with the printer selected, obtain, from the printer, access information used to access a server using connection information indicating a connection destination to which the printer is connected, obtain, from the server, service information regarding a service provided by the server and applied to the printer using the access information, and display information based on the service information.

### REFERENCE TO RELATED APPLICATIONS

This application is a continuation of PCT International Application No. PCT/JP2023/011794 filed on Mar. 24, 2023, and claims priority from Japanese Patent Application No. 2022-055385 filed on Mar. 30, 2022, which are incorporated herein by reference in their entirety.

### BACKGROUND ART

In recent years, a technology has been put to practical use in which a printer is controlled by a general-purpose print program that is incorporated as standard into an operating system (hereinafter referred to as an “OS”) of an information processing device, without using a printer driver. In this technology, the OS associates the printer with the OS-standard general-purpose print program in response to detecting the printer, and thereafter, the information processing device is enabled to cause the printer to perform printing with the OS-standard general-purpose print program without using a printer driver in response to receiving a print instruction to the printer.

In addition, a communication system has been known that includes a mobile terminal, a service providing server, a multi-function peripheral (hereinafter referred to as an “MFP”), and an intermediary server. In the known communication system, the mobile terminal is configured to access the service providing server using a browser, receive thumbnail data indicating a thumbnail page from the service providing server, and send a URL of the thumbnail data to the MFP. The MFP is configured to receive the URL of the thumbnail data from the mobile terminal and send the received URL to the intermediary server. The intermediary server is configured to, after receiving the URL of the thumbnail data from the MFP, cause a display of the MFP to display one or more pieces of account information that are allowed to receive a service provided by the service providing server among the account information currently stored in the multi-function peripheral.

### SUMMARY

For the known communication system, there is also known technology to access a server by activating the browser from the mobile terminal in order to obtain, from the server, information about a service provided by the server. In addition, an application program (e.g., a print application) provided by a printer vendor may have a browser function. In this case, the server may be accessed via the print application. The server may also be accessed via a printer driver. Even in an environment where an OS-standard general-purpose print program is used, it is possible to obtain the information about the service provided by the server by activating a separate browser to access the server. In this case, however, it is desirable to reduce user effort required to access the server.

Aspects of the present disclosure are advantageous for providing one or more techniques for improving a procedure for an information processing device with an OS-standard general-purpose print program incorporated therein to access a service providing server.

According to aspects of the present disclosure, a non-transitory computer-readable storage medium is provided, which stores computer-readable instructions that are executable by a computer of an information processing device and compatible with a particular printer. The computer-readable instructions realize a support program supporting a general-purpose print program incorporated in advance in an operating system of the information processing device. The support program is configured to, when executed by the computer, cause the information processing device to, in response to receiving a request for processing from the general-purpose print program of the operating system when the operating system has accepted an activation instruction to activate the support program compatible with the particular printer with the particular printer selected, obtain access information from the particular printer using connection information. The access information is used to access a server. The connection information indicates a connection destination to which the particular printer is connected. The support program is further configured to, when executed by the computer, cause the information processing device to obtain service information from the server using the obtained access information. The service information is information regarding a service provided by the server and applied to the particular printer. The support program is further configured to, when executed by the computer, cause the information processing device to display information based on the obtained service information.

According to aspects of the present disclosure, further provided is an information processing device that includes a display and a controller. The controller includes a computer and a non-transitory computer-readable storage medium. The non-transitory computer-readable storage medium stores a general-purpose print program incorporated in advance in an operating system of the information processing device. The non-transitory computer-readable storage medium further stores computer-readable instructions realizing a support program that is compatible with a particular printer and supports the general-purpose print program. The support program is configured to, when executed by the computer, cause the controller to, in response to receiving a request for processing from the general-purpose print program of the operating system when the operating system has accepted an activation instruction to activate the support program compatible with the particular printer with the particular printer selected, obtain access information from the particular printer using connection information. The access information is used to access a server. The connection information indicates a connection destination to which the particular printer is connected. The support program is further configured to, when executed by the computer, cause the controller to obtain service information from the server using the obtained access information. The service information is information regarding a service provided by the server and applied to the particular printer. The support program is further configured to, when executed by the computer, cause the controller to display information based on the obtained service information on the display.

According to aspects of the present disclosure, further provided is a method implementable by a computer executing computer-readable instructions on an information processing device. The computer-readable instructions are compatible with a particular printer and realize a support program supporting a general-purpose print program incorporated in advance in an operating system of the information processing device. The method includes obtaining, in response to receiving a request for processing from the general-purpose print program of the operating system when the operating system has accepted an activation instruction to activate the support program compatible with the particular printer with the particular printer selected, access information from the particular printer using connection information, by the support program. The access information is used to access a server. The connection information indicates a connection destination to which the particular printer is connected. The method further includes obtaining, by the support program, service information from the server using the obtained access information, the service information being information regarding a service provided by the server and applied to the particular printer. The method further includes displaying, by the support program, information based on the obtained service information.

### BRIEF DESCRIPTION OF DRAWINGS

FIG. 1 schematically shows a printing system and a customer management system for providing printing services to the printing system.

FIG. 2 is a block diagram schematically showing a configuration of the printing system.

FIG. 3 shows an example of various types of information stored in a printer storage.

FIG. 4 shows an example of customer contract information stored in a customer database.

FIG. 5 shows an example of customer contract information stored in a customer database.

FIG. 6 is a sequence diagram showing an example procedure of a printing service process, provided to a user by auxiliary programs, which includes operations and processes by an OS, a printer, and a customer management server.

FIG. 7A shows an example of a “Bluetooth and Devices” screen.

FIG. 7B shows an example of a “Printers and Scanners” screen.

FIG. 8 shows an example of a printer screen.

FIG. 9 shows an example of a startup screen.

FIG. 10A shows an example of a user name selection screen.

FIG. 10B shows an example of a menu screen.

FIG. 11A shows an example of a rate plan addition screen.

FIG. 11B shows an example of a consumable ordering screen.

FIG. 12A shows an example of a password setting screen.

FIG. 12B shows an example of a rate plan selection screen.

FIG. 13A shows an example of a payment method selection screen.

FIG. 13B shows an example of a final confirmation screen.

FIG. 14 is a sequence diagram showing an example procedure in response to a print execution instruction from the user.

FIG. 15 is a sequence diagram showing an example procedure of a printing service process, provided to the user by the auxiliary programs, which includes operations and processes by the OS, the printer, and the customer management server.

### DESCRIPTION

It is noted that various connections are set forth between elements in the following description. It is noted that these connections in general and, unless specified otherwise, may be direct or indirect and that this specification is not intended to be limiting in this respect. Aspects of the present disclosure may be implemented on circuits (such as application specific integrated circuits) or in computer software as programs storable on computer-readable media including but not limited to RAMs, ROMs, flash memories, EEPROMs, CD-media, DVD-media, temporary storage, hard disk drives, floppy drives, permanent storage, and the like.

In the present disclosure, an inclusive OR, meaning that it includes either A or B or both, may be expressed as “A and/or B,” “at least one of A or B,” or “at least one selected from the group consisting of A and B.” The same applies to a case where there are three or more selectable elements to consider.

### First Illustrative Embodiment

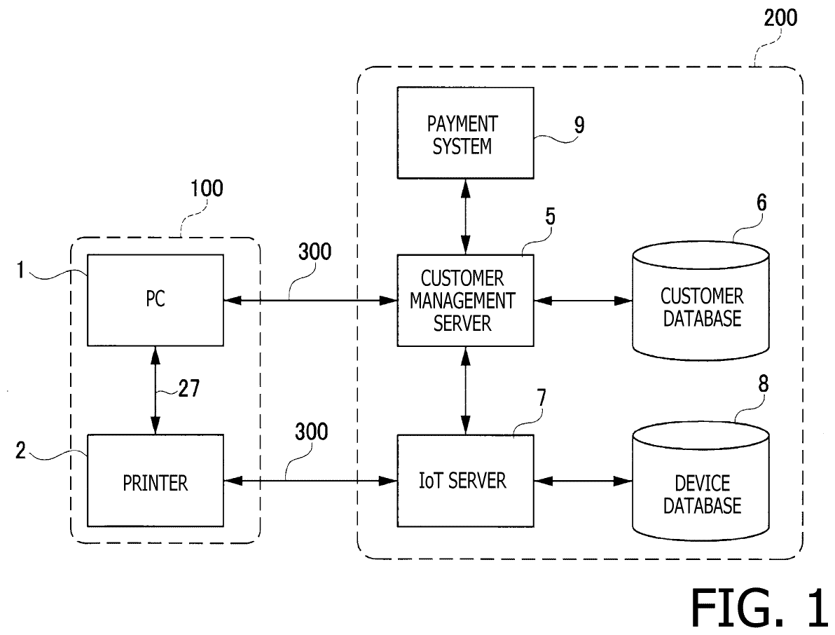

A printing system using a support program in a first illustrative embodiment according to aspects of the present disclosure will be described in detail below with reference to the relevant accompanying drawings. FIG. 1 schematically shows a printing system 100 and a customer management system 200 managed by a vendor to provide printing services to the printing system.

Namely, as shown in FIG. 1, the printing system 100 in the first illustrative embodiment is applicable to the printing services provided by the vendor to a user. In addition, the printing services in the first illustrative embodiment is provided to the user using the customer management system 200 managed by the vendor. The printing services in the first illustrative embodiment include a service in which the vendor charges for the number of pages (or sheets) printable using the printing system 100, such that the user is only permitted to print the number of printable pages (or sheets) for which the vendor has charged. The printing services may include a service in which the vendor charges for the amounts of consumables used in the printing system 100. Further, the printing services may include a printing service in which the vendor charges for the number of pages (or sheets) printed, including the cost of consumables. As described above, in the printing services of the first illustrative embodiment, the vendor may charge for the number of pages printable using the printing system 100 or for the number of sheets printable using the printing system 100. It is noted that the following explanation will be provided of a case where the vendor may charge for the number of pages printable using the printing system 100.

In the printing services of the first illustrative embodiment, the user is provided with a particular number of printable pages (e.g., 6,000 pages) by paying an initial fee at the time of initial setup when the printing system 100 is first connected to the customer management system 200 after the user applies for the printing services to the vendor. If the user wishes to print more than the particular number of printable pages, the user is required to pay an additional fee to the vendor. The user is allowed to continue to use the printing system 100 by purchasing an additional number of printable pages. If the user repeatedly purchases the additional number of printable pages, and thus the remaining amounts of the initial consumables (e.g., the initial ink or toner) for the printing system 100 become small, the user may continue to use the printing services by applying for the purchase of new consumables. If the printing services include a printing service in which the cost of consumables is charged as part of the charge for the number of pages printed, the user needs to arrange for new consumables.

In the first illustrative embodiment, the printing system 100 includes a personal computer (hereinafter referred to as a “PC”) 1 and a printer 2. In the first illustrative embodiment, the printer 2 is an inkjet printer, and a consumable item is ink. However, practicable examples are not limited to this example. The printing system 100 of the first illustrative embodiment may be configured such that the single printer 2 is used by a single user, or such that the single printer 2 is used by a plurality of users. In the printing system 100 of the first illustrative embodiment, the PC 1 is owned by a user, and only the printer 2 is provided by the vendor. However, a configuration in which both the PC 1 and the printer 2 are provided by the vendor is also acceptable.

The customer management system 200 for managing the printing services in the first illustrative embodiment includes a group of servers on the Internet that are managed by the vendor, i.e., so-called cloud-type servers. The customer management system 200 of the first illustrative embodiment includes a customer management server 5 provided with a customer database 6, and an IoT server 7 provided with a device database 8. The customer management server 5 is connected with a payment system 9. In the first illustrative embodiment, the payment system 9 uses, for instance, online payments, including credit card payments. Other practicable examples of online payment methods may include, but are not limited to, mobile carrier payments, electronic money, bank (postal) transfers, and convenience store payments. In addition, the payment system 9 may use any payment methods other than online payments.

The customer management server 5 is communicably connected with the PC 1 via the Internet 300. The IoT server 7 is communicably connected with the printer 2 via the Internet 300. The customer management server 5 may be connected with the IoT server 7 via the Internet 300 or via a LAN. In the first illustrative embodiment, the customer management server 5 and the IoT server 7 are configured with respective separate servers. However, the customer management server 5 and the IoT server 7 may be configured with the same single server.

### Configuration of Printing System

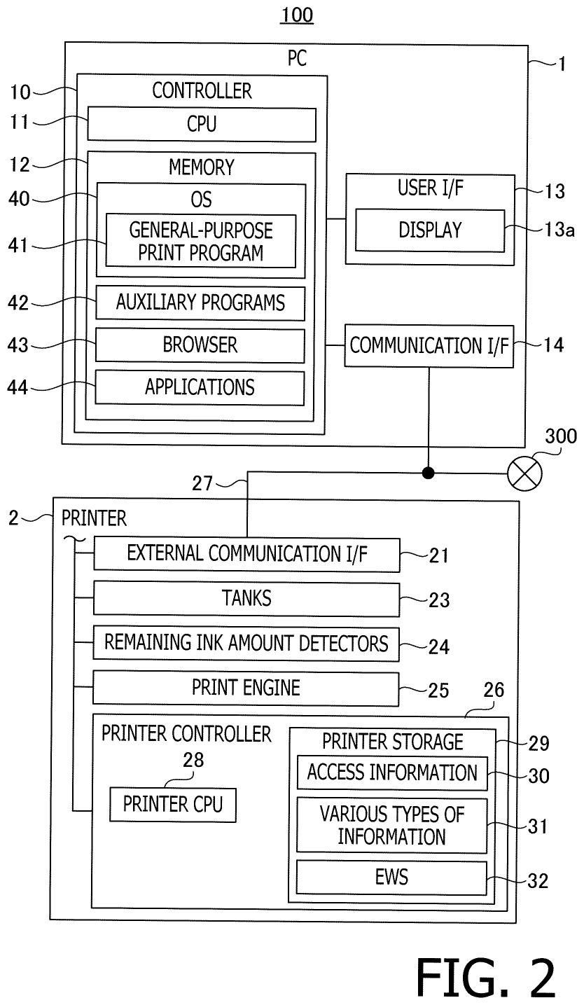

FIG. 2 is a block diagram schematically showing a configuration of the printing system 100 in the first illustrative embodiment. As shown in FIG. 2, the PC 1 included in the printing system 100 in the first illustrative embodiment has a controller 10 that includes a CPU 11 and a memory 12. The PC 1 may be an example of an “information processing device” according to aspects of the present disclosure. The CPU 11 may be an example of a “computer” according to aspects of the present disclosure. The PC 1 further includes a user interface (hereinafter referred to as a “user I/F”) 13 and a communication interface (hereinafter referred to as a “communication I/F”) 14, which are electrically connected with the controller 10. The “controller 10” in FIG. 1 is a collective term for hardware and software used to control the PC 1, and may not necessarily represent a single hardware element actually existing in the PC 1.

The CPU 11 is configured to perform various processes according to programs read from the memory 12 and based on user operations. The memory 12 stores various types of data and various programs. The memory 12 is also used as a work area when various processes are performed. A buffer provided to the CPU 11 may be an example of a “memory” according to aspects of the present disclosure. Examples of the memory 12 are not limited to a ROM, a RAM, and an HDD that are incorporated in the PC 1, but may include storage media (e.g., CD-ROMs and DVD-ROMs) that are readable and writable by the CPU 11.

The user I/F 13 includes a display 13a that is hardware configured to display screens to provide information to the user, and hardware configured to receive user operations. The user I/F 13 may have a combination of the display 13a configured to display information, and a mouse and/or a keyboard that are configured to accept user input operations, i.e., having an input acceptance function. The user I/F 13 may include a touch panel having the display 13a and the input acceptance function.

The communication I/F 14 includes hardware configured to communicate with external devices such as the printer 2. Communication standards applicable for the communication I/F 14 include Ethernet (“Ethernet” is a registered trademark of Fuji Xerox Co., Ltd.), Wi-Fi (“Wi-Fi” is a registered trademark of the non-profit Wi-Fi Alliance), and USB. The PC 1 is connected with the customer management server 5 via the Internet 300 and the communication I/F 14, and is configured to perform intercommunication of signals with the customer management server 5. The PC 1 may have a plurality of communication I/Fs 14 conforming to a plurality of communication standards.

As shown in FIG. 2, the memory 12 of the PC 1 stores an operating system (hereinafter referred to as an “OS”) 40 that includes a general-purpose print program 41, auxiliary programs 42, a browser 43, and various application programs (hereinafter referred to as “applications”) 44. Examples of the OS 40 may include, but are not limited to, Windows (“Windows” is a registered trademark of Microsoft Corporation), macOS (“macOS” is a registered trademark of Apple Inc.), Linux (“Linux” is a registered trademark of Linus Torvalds), iOS (“iOS” is a registered trademark of Cisco Systems, Inc.), and Android (“Android” is a registered trademark of Google LLC). The auxiliary programs 42 may be an example of the “support program” according to aspects of the present disclosure, and may be an example of “computer-readable instructions” according to aspects of the present disclosure.

The general-purpose print program 41 is an OS-standard program provided with the OS 40 and has a function to cause the printer 2 to print information that is displayed on the display 13a by the browser 43 or the applications 44. The general-purpose print program 41 in the first illustrative embodiment is a program having a function for generating intermediate image data based on image data to be printed. The general-purpose print program 41 supports functions that are usable in common by a plurality of printer models provided by vendor(s) of various printers. Unlike printer drivers that are specific to individual printers, the general-purpose print program 41 does not support all of the functions that are unique to the individual printers. Functions supportable by the general-purpose print program 41 are limited to generic functions.

The auxiliary programs 42 include one program or a group of programs configured to, when executed by the CPU 11, cause the PC 1 to perform processing based on instructions from the OS 40, accompanying processing by the general-purpose print program 41. The auxiliary programs 42 include one or more programs that support control of target hardware elements. The auxiliary programs 42 in the first illustrative embodiment are compatible with a model of the printer 2 connected with the PC 1. The auxiliary programs 42 are launched from the general-purpose print program 41, for instance, when the PC 1 has received an instruction to cause the printer 2 to perform printing using the general-purpose print program 41. The auxiliary programs 42 are called, for instance, PSA (“PSA” is an abbreviation for “Print Support Application”) or HSA (“HSA” is an abbreviation for “Hardware Support Application”).

For instance, the auxiliary programs 42 may include a combination of a plurality of programs each of which is configured to, when executed by the CPU 11, cause the PC 1 to accept execution instructions. In another instance, the auxiliary programs 42 may include one program configured to, when executed by the CPU 11, cause the PC 1 to accept instructions and perform respective different processes according to the accepted instructions. The auxiliary programs 42 may include a program prepared for each type of printer by the printer vendor(s). For instance, the auxiliary programs 42 may include an auxiliary program prepared for inkjet printers and an auxiliary program prepared for laser printers. The auxiliary programs 42 may include not only the auxiliary program prepared for each type of printer but also an auxiliary program prepared for each model of printer or an auxiliary program prepared for each series of models of printers.

For instance, when a new printer is connected with the PC 1, the OS 40 may cause the PC 1 to download an appropriate auxiliary program (e.g., the auxiliary programs 42) from a server or another source depending on a type of the connected printer and to incorporate the downloaded auxiliary program into the PC 1. Then, the OS 40 may cause the PC 1 to store identification information of the incorporated auxiliary program in the memory 12 in association with printer information of the newly connected printer.

The browser 43 is a program used to browse websites. The browser 43 is configured to, when activated, e.g., by an employee (a user), display on the display 13a a web page provided by a web server (e.g., in the first illustrative embodiment, an after-mentioned EWS 32 of the printer 2) indicated by a specified URL.

Examples of the applications 44 incorporated in the PC 1 in the first illustrative embodiment may include, but are not limited to, an information application and an office application. Examples of the information application as an application 44 may include, but are not limited to, a map application, and a calendar application. The information application is configured to, when activated, e.g., by an employee (a user), display various types of information on the display 13a in response to user's requests. It is noted that the browser 43 may be incorporated in the information application. The information application itself may or may not have a function to cause a printer to print the displayed information.

Examples of the office application as an application 44 may include, but are not limited to, a word processing application, a spreadsheet application, and a presentation application. The office application is configured to, when activated, e.g., by an employee (a user), accept via the user I/F 13 various types of input such as image data representing an image, edits to the image, print settings, designation of a printer to perform printing, and a print execution instruction.

As shown in FIG. 2, the printing system 100 in the first illustrative embodiment includes the printer 2 connected with the PC 1. In the first illustrative embodiment, the printer 2 is a color inkjet printer. However, the printer 2 may be a color laser printer or a label printer. The printer 2 includes an external communication interface (hereinafter referred to as an “external communication I/F”) 21, tanks 23, remaining ink amount detectors 24, a print engine 25, and a printer controller 26. The external communication I/F 21, the remaining ink amount detectors 24, and the print engine 25 are electrically connected with the printer controller 26. It is noted that the printer controller 26 in FIG. 2 is a collective term for the hardware and software used to control the printer 2, and may not necessarily represent a single piece of hardware actually existing in the printer 2.

The external communication I/F 21 includes hardware configured to perform communication with external devices such as the PC 1. The external communication I/F 21 is connected with the PC 1 via a wired LAN 27. Communication standards applicable for the external communication I/F 21 include Ethernet (“Ethernet” is a registered trademark of Fuji Xerox Co., Ltd.), Wi-Fi (“Wi-Fi” is a registered trademark of the non-profit Wi-Fi Alliance), and USB. In addition, the printer 2 is connected with the IoT server 7 via the external communication I/F 21 and the Internet 300, and is configured to perform intercommunication of signals with the IoT server 7. The printer 2 may be connected with the PC 1 via a USB.

Each tank 23 is configured to store ink. In the first illustrative embodiment, there are four types of ink (magenta M, cyan C, yellow Y, and black BK). For each type of ink, a corresponding one of the plurality of tanks 23 is provided. Namely, the printer 2 uses the plurality of tanks 23 to store the respective four types of ink independently. In the first illustrative embodiment, when the printer 2 is supplied from the vendor to the user, each of the plurality of tanks 23 is filled with an amount of ink that enables the particular number of pages to be printed.

Each remaining ink amount detector 24 is disposed at a corresponding one of the plurality of tanks 23 and configured to detect a remaining amount of ink stored in the corresponding tank 23. More specifically, each remaining ink amount detector 24 includes an optical sensor disposed at the corresponding tank 23 and configured to detect the remaining amount of ink stored in the corresponding tank 23 by detecting a liquid surface level of the ink stored therein.

The print engine 25 is configured to perform printing using the ink stored in the tanks 23. Specifically, the print engine 25 is configured to perform processing to print an image represented by data obtained from the PC 1 on a sheet using a known inkjet method.

The printer controller 26 is configured to take overall control of the printer 2. The printer controller 26 includes a printer CPU 28 and a printer storage 29. The printer CPU 28 is configured to perform various types of processing according to programs read from the printer storage 29 and based on user operations. The printer storage 29 stores various programs and various types of data. The printer storage 29 may include a combination of at least two selected from a plurality of memory devices such as RAMs, ROMs, flash memories, HDDs, buffers provided to the printer CPU 28, and others.

The printer storage 29 stores access information 30, various types of information 31, and a program for an EWS (“EWS” is an abbreviation for “Embedded Web Server”) 32. Therefore, in the printer 2, the EWS 32 is activated by launching and executing the program for the EWS 32. Thus, in the first illustrative embodiment, by using functions of the EWS 32 of the printer 2, the PC 1 is enabled to manage the printer 2 and configure various settings for the printer 2 via the browser 43. The access information 30 includes URL (“URL” is an abbreviation for “Uniform Resource Locator”) information and an IP address of the customer management server 5 that are used to access the customer management server 5. The access information 30 further includes URL information and an IP address of the IoT server 7 that are used to access the IoT server 7.

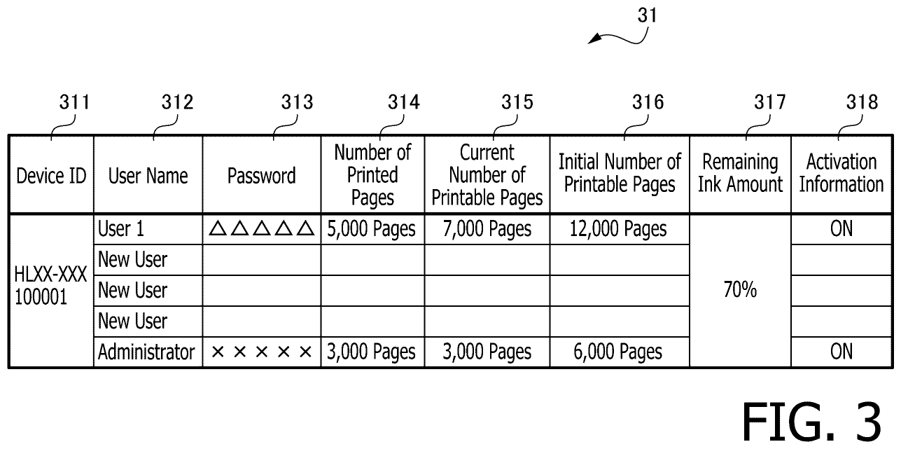

The various types of information 31 store, as a table, each information about the printer 2 with respect to the use of the printing services. As shown in FIG. 3, the various types of information 31 include a device ID 311, a user name 312, a password 313, the number of printed pages 314, a current number of printable pages 315, an initial number of printable pages 316, a remaining ink amount 317, and activation information 318.

The device ID 311 is used to identify the printer 2. For instance, the device ID 311 includes a combination of a model name and a serial number of the printer 2. The user name 312 represents a name of each potential user who may use the printing services. The password 313 represents a password set by each user registered with the user name 312. The password 313 is used in a procedure for the printing services or when printing is performed. The number of printed pages 314 represents the number of pages printed by the printer 2. The number of printed pages 314 is stored in association with each user registered with the user name 312. For instance, the user name 312 may be a nickname of each user or a name code used by a company that employs each user.

The current number of printable pages 315 represents the number of pages printable by the printer 2. The initial number of printable pages 316 represents an initial number of printable pages that is set as a result of each user being charged for the use of the printing services in the first illustrative embodiment. The initial number of printable pages 316 is set according to the amount charged. When a user purchases an additional number of printable pages, the purchased number of printable pages is added to the initial number of printable pages 316. The current number of printable pages 315 represents the number of pages obtained by subtracting the number of pages printed by the printer 2 (i.e., the value of the number of printed pages 314) from the initial number of printable pages 316.

The remaining ink amount 317 represents a remaining amount of ink detected by the ink amount detectors 24. When the activation information 318 is set to an ON state, the print engine 25 is allowed to perform printing. When the activation information 318 is set to an OFF state, the print engine 25 is restricted from performing printing.

### Customer Management System

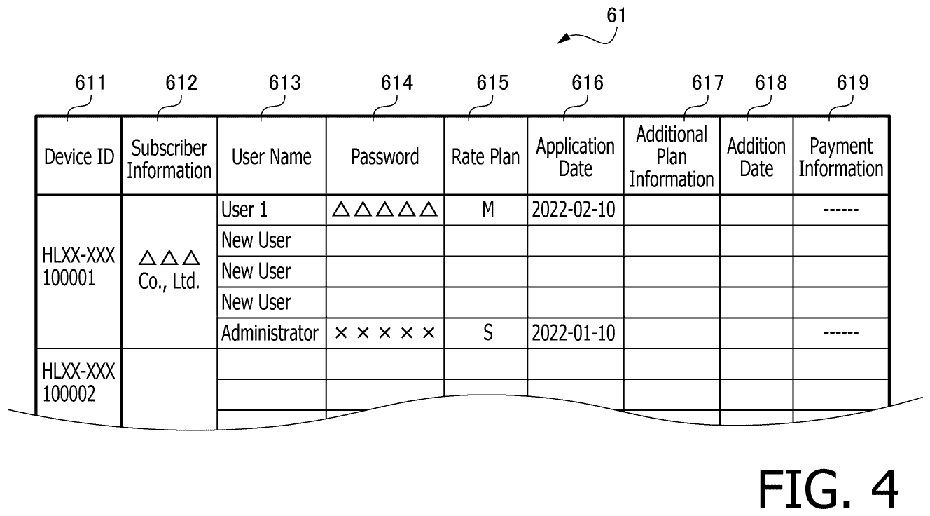

Next, the customer management system 200 is briefly described. The customer database 6 connected with the customer management server 5 stores, as a table, customer contract information 61 shown in FIG. 4. The customer contract information 61 includes, for each subscriber, a device ID 611, subscriber information 612, a user name 613, a password 614, a rate plan 615, an application date 616, additional plan information 617, an addition date 618, and payment information 619.

The device ID 611 represents identification information to identify the printer 2 provided to each subscriber of the printing services in the first illustrative embodiment. The device ID 611 is the same as the device ID 311 in the various types of information 31 stored in the printer 2. The subscriber information 612 represents information about each subscriber. For instance, the subscriber information 612 may include at least one selected from a name, an address, contact information, and an e-mail address of the individual or organization (corporation) that has concluded a contract with the vendor for the printing services in the first illustrative embodiment.

The user name 613 represents a name of each potential user who may use the printing services. The user name 613 is the same as the user name 312 in the various types of information 31 stored in the printer 2. It is noted that “Administrator” registered for the user name 613 represents a user designated as an administrator by the subscriber at the time of the contract for the printing services. The subscriber and the administrator may be one and the same. In the first illustrative embodiment, a plurality of users may be set for the one contract. However, a configuration such that only one user may be set for the one contract is acceptable. The user name 613 is configured to store the name of each user set in advance by the subscriber at the time of the contract. The user name 613 is further configured to store a name of a new user added after the contract.

The password 614 represents a password set by each user registered for the user name 613. The password 614 is the same as the password 313 in the various types of information 31 stored in the printer 2. The rate plan 615 represents a rate plan set by the administrator or each user. The application date 616 represents a date when the user applied for the contract for the printing service in the first illustrative embodiment. The additional plan information 617 represents an additional plan added by the administrator. The addition date 618 represents a date when the additional plan was added by the administrator. The payment information 619 represents information regarding a payment made with the payment system 9. For instance, the payment information 619 may include at least one selected from card information of a card used for the payment, a payment status, and a payment date.

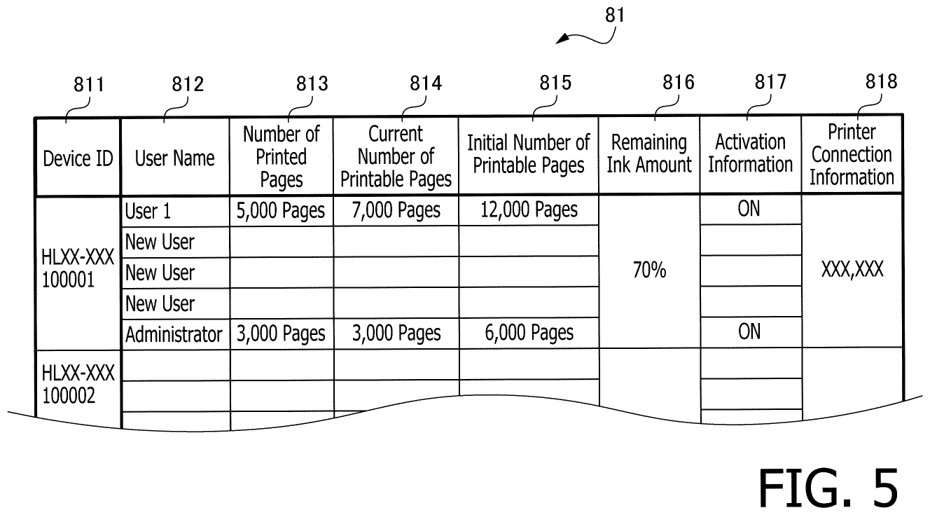

The device database 8 connected with the IoT server 7 stores, as a table, service record information 81 shown in FIG. 5. The service record information 81 includes, for each printer 2 provided to a corresponding subscriber of the printing services, a plurality of pieces of information such as a device ID 811, a user name 812, the number of printed pages 813, a current number of printable pages 814, an initial number of printable pages 815, a remaining ink amount 816, activation information 817, and printer connection information 818. The device ID 811, the user name 812, the number of printed pages 813, the current number of printable pages 814, the initial number of printable pages 815, the remaining ink amount 816, and the activation information 817 are the same as the device ID 311, the user name 312, the number of printed pages 314, the current number of printable pages 315, the initial number of printable pages 316, the remaining ink amount 317, and the activation information 318 in the various types of information 31 stored in the printer 2, respectively. The printer connection information 818 represents information regarding the connection with the printer 2. For instance, the printer connection information 818 may include at least one selected from an IP address of the printer 2, URL information of the EWS 32 of the printer 2, and an IP address of the EWS 32 of the printer 2.

The IoT server 7 is configured to use the printer connection information 818 to periodically access each printer 2 provided to the corresponding subscriber of the printing services in the first illustrative embodiment, collect the various types of information 31 stored in the printer storage 29 of each printer 2, and store the collected various types of information 31 in the device database 8. The number of printed pages 813 and the activation information 817 are updated by each printer 2 when printing by each printer 2 is completed.

### Printing Service Process

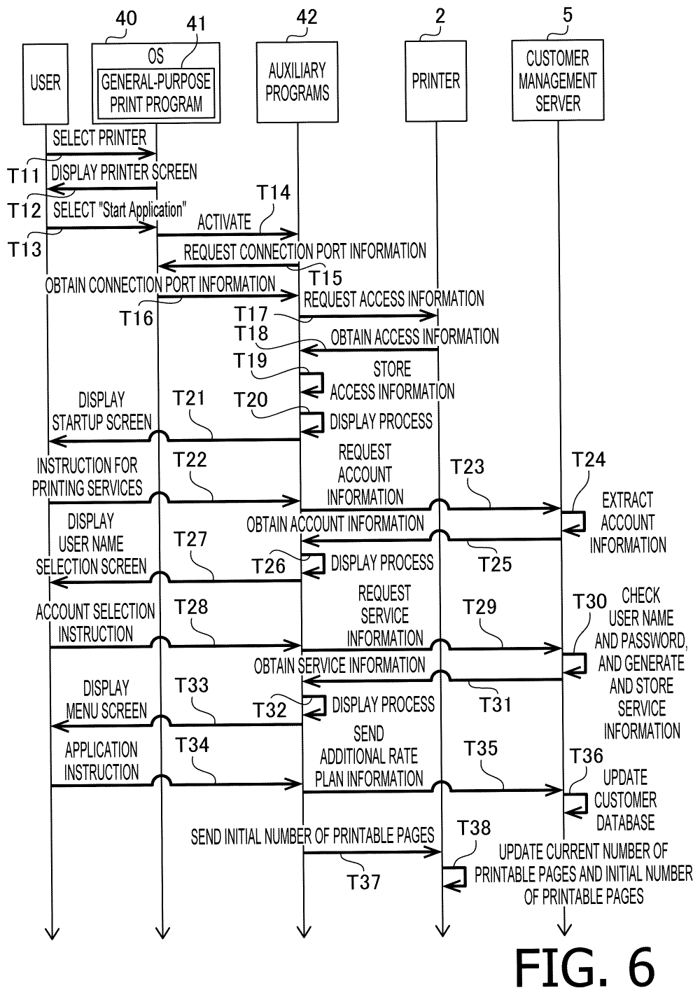

Subsequently, with reference to a sequence diagram shown in FIG. 6, an explanation will be provided of an example procedure of a printing service process, provided to the user by the auxiliary programs 42, which includes operations and processes by the OS 40, the printer 2, and the customer management server 5, in the first illustrative embodiment. FIG. 6 and the after-mentioned other sequence diagrams show a sequence of operations and processes when the auxiliary programs 42 compatible with the printer 2 are incorporated in the PC 1.

Each processing step in the first illustrative embodiment generally indicates processing by the CPU 11 primarily in accordance with instructions described in the auxiliary programs 42 and other programs. The processing by the CPU 11 includes hardware control using an API (“API” is an abbreviation for “Application Programming Interface”) of the OS 40. In the present disclosure, operations and processes by individual programs are described without a detailed description of the OS 40.

In the printing services of the first illustrative embodiment, after a subscriber first enters into a contract for the printing services with the vendor, the printer 2 is delivered by the vendor to an administrator. The administrator is a user designated as the administrator by the subscriber at the time of the contract. However, the subscriber and the administrator may be the same person. Next, the administrator (user) connects the provided printer 2 to the PC 1, and then the after-mentioned printing service process is performed mainly on the PC 1.

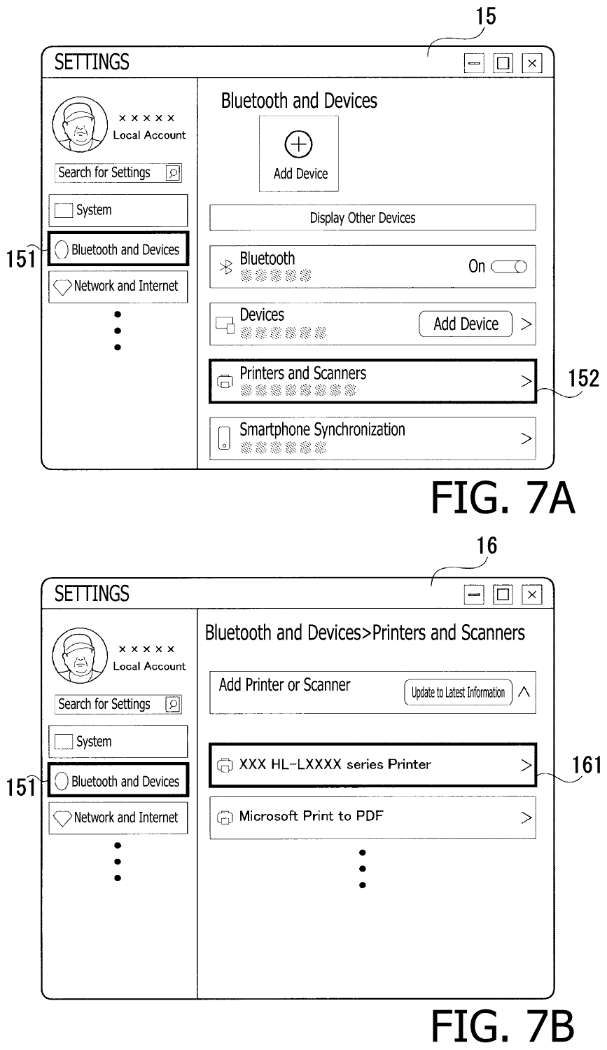

At the beginning of the procedure, for instance, when the user has clicked a start menu (not shown) on a start screen (not shown) of the OS 40 that is displayed on the display 13a, via the user I/F 13, the OS 40 causes the display 13a to display a start menu screen (not shown). When the user has then clicked a “Settings” button (not shown) on the start menu screen displayed on the display 13a via the user I/F 13, the OS 40 causes the display 13a to display a setting screen (not shown). Thereafter, when the user has clicked the “Bluetooth and Devices” button 151 from a menu displayed on the setting screen via the user I/F 13, the OS 40 causes the display 13a to display a “Bluetooth and Devices” screen 15, e.g., as shown in FIG. 7A.

Afterward, when the user has clicked a “Printers and Scanners” button 152 on the “Bluetooth and Devices” screen 15 displayed on the display 13a via the user I/F 13, the OS 40 causes the display 13a to display a “Printers and Scanners” screen 16, e.g., as shown in FIG. 7B. For instance, as shown in FIG. 7B, on the “Printers and Scanners” screen 16, respective printer selection buttons associated with individual printers are listed, and the list includes a printer selection button 161 associated with the printer 2. Specifically, each printer selection button is associated with a printer queue managed by the OS 40, and an individual printer queue is generated for each printer by the OS 40.

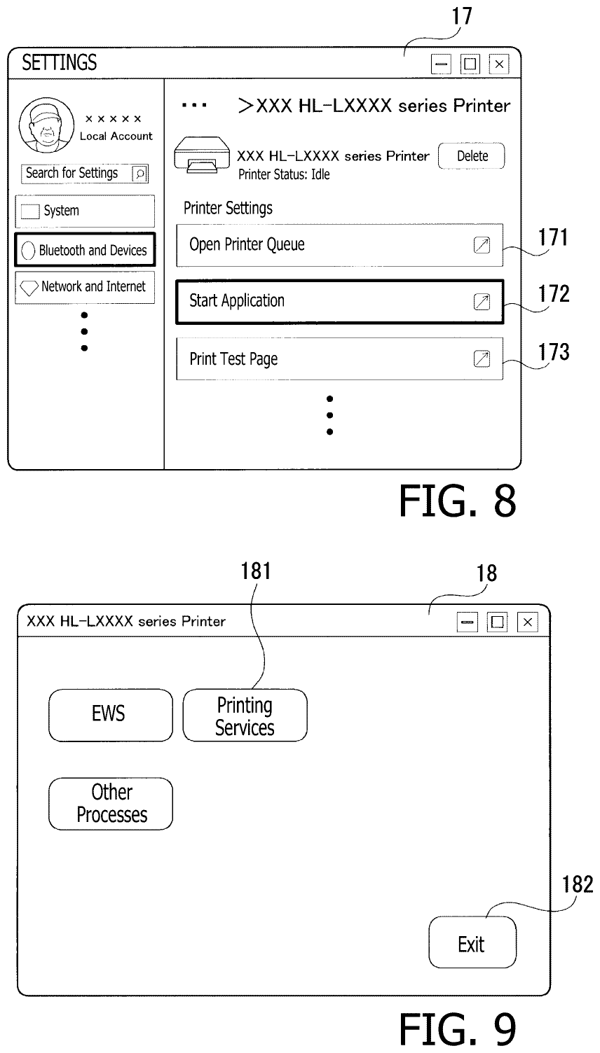

When the user has then clicked the printer selection button 161 on the “Printers and Scanners” screen 16 via the user I/F 13 (T11 in FIG. 2), the OS 40 causes the display 13a to display a printer screen 17 for the printer 2 that is associated with the printer selection button 161, e.g., as shown in FIG. 8 (T12). For instance, the printer screen 17 includes operable buttons displayed thereon, such as an “Open Printer Queue” button 171, a “Start Application” button 172, and a “Print Test Page” button 173.

Thereafter, when the user has clicked the “Start Application” button 172 displayed on the printer screen 17 via user I/F 13 (T13), the general-purpose print program 41 of the OS 40 activates the auxiliary programs 42 compatible with the currently selected printer 2 (T14).

The OS 40 stores printer information and program identification information in the memory 12 in association with each other. When the printer information of the selected printer is associated with the printer identification information of a program, the general-purpose print program 41 activates the program identified by the associated printer identification information in response to a click operation on the “Start Application” button 172. The printer information of a printer and the program identification information of a program are associated with each other, for instance, when the print queue is generated, or when the program is installed. In the first illustrative embodiment, the printer information of the printer 2 is associated with the identification information of the auxiliary programs 42. In response to a click operation on the “Start Application” button 172 with the printer 2 selected, the general-purpose print program 41 activates the auxiliary programs 42.

When activated from the general-purpose print program 41 of the OS 40 in response to the click operation on the “Start Application” button 172, the auxiliary programs 42 send a request for connection port information of the printer 2 to the OS 40 (T15). In response to receiving the request for the connection port information, the OS 40 sends the connection port information to the auxiliary programs 42. Thus, the auxiliary programs 42 obtain the connection port information (T16).

For instance, when the PC 1 and the printer 2 are connected with each other via the wired LAN 27, the auxiliary programs 42 obtain, as the connection port information, information on a port connected with the wired LAN 27 and the IP address of the printer 2. When the PC 1 and the printer 2 are connected with each other via a USB, the auxiliary programs 42 obtain, as the connection port information, information on a port assigned to the USB.

Then, based on the obtained connection port information, the auxiliary programs 42 send a request for transmission of the access information 30 to the printer 2 using, for instance, an MIB (“MIB” is an abbreviation for “Management Information Base”) (T17). In response to receiving the request, the printer 2 reads the access information 30 stored in the printer storage 29, and the device ID 311 from the various types of information 31 in the printer storage 29, and sends the read access information 30 and the read device ID 311 to the PC 1. Thus, the auxiliary programs 42 obtain the access information 30 and the device ID 311 (T18). Thereafter, the auxiliary programs 42 store the obtained access information 30 and the obtained device ID 311 in the memory 12 (T19).

In the first illustrative embodiment, the auxiliary programs 42 are configured to obtain the access information 30 and the device ID 311 directly from the printer 2 using, for instance, the MIB. However, practicable examples are not limited to this. For instance, the auxiliary programs 42 may be configured to obtain the access information 30 and the device ID 311 via the general-purpose print program 41 of the OS 40. In this case, the auxiliary programs 42 may send a request for the access information 30 and other information to the general-purpose print program 41. In response to the request, the general-purpose print program 41 may send a request for capability information to the printer 2 using IPP (“IPP” is an abbreviation for “Internet Printing Protocol”). The printer 2 may read the access information 30 and the device ID 311 stored in the printer storage 29 and send the capability information including the read access information 30 and the read device ID 311 in response to the request from the general-purpose print program 41. Then, the general-purpose print program 41 may pass the capability information received from the printer 2 to the auxiliary programs 42. In this case, the auxiliary programs 42 obtain the access information 30 and the device ID 311 indirectly via the OS 40, and do not need to perform the process of T17 to T18.

Afterward, the auxiliary programs 42 perform a display process to display a startup screen 18 (T20), and then cause the display 13a to display the startup screen 18, for instance, as shown in FIG. 9 (T21). The startup screen 18 is configured to display thereon a “Printing Services” button 181 and an exit button 182. When the user has clicked the exit button 182 via the user I/F 13, the PC 1 stops displaying the startup screen 18.

When the user has clicked the “Printing Services” button 181 via the user I/F 13 (T22) while the startup screen 18 (see FIG. 9) is being displayed on the display 13a, the auxiliary programs 42 access the customer management server 5 based on the access information 30 obtained in T18, and send a request for account information (T23). The request for account information includes the device ID 311 of the printer 2 as obtained in T18.

Thus, in the first illustrative embodiment, when the “Start Application” button 172 is clicked, the auxiliary programs 42 access the customer management server 5 based on the access information 30 obtained in T18. Therefore, the user does not need to enter access destination information of the customer management server 5 each time the user attempts to access the customer management server 5, thereby improving the convenience of accessing the customer management server 5.

In response to receiving the request for account information, the customer management server 5 accesses the customer contract information 61 in the customer database 6, and extracts, based on the device ID 311 of the printer 2 sent by the PC 1, account information (i.e., the user name 613) corresponding to the device ID 311 (T24). The customer management server 5 then sends the extracted user name 613 to the PC 1 as the account information.

Accordingly, after obtaining the account information (i.e., the user name 613) sent by the customer management server 5 (T25), the auxiliary programs 42 store the user name 613 in the memory 12.

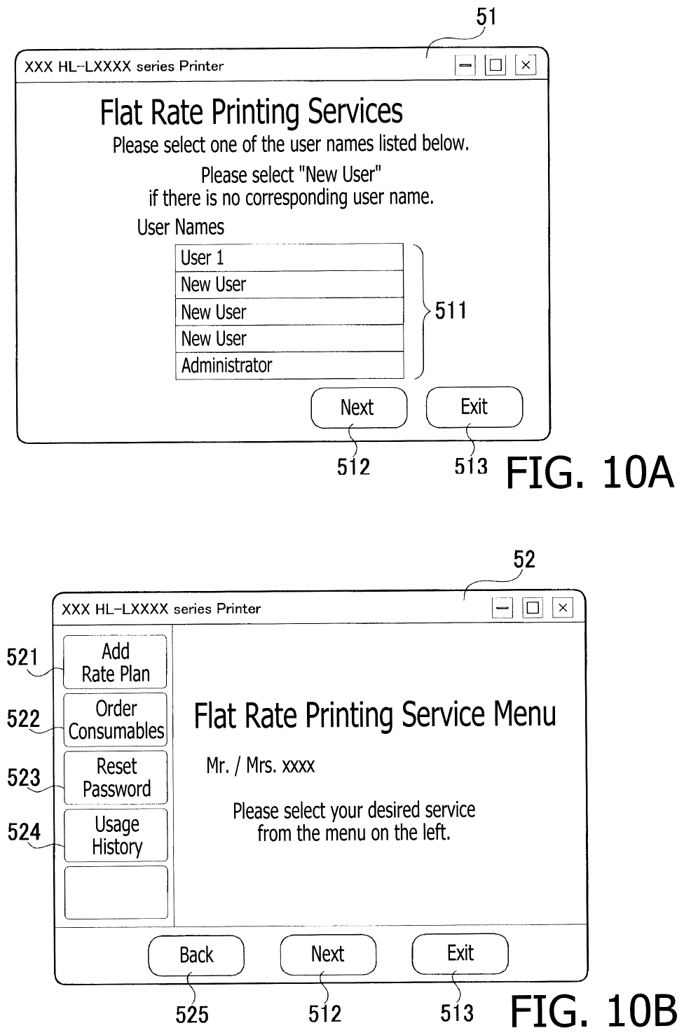

Next, the auxiliary programs 42 perform a display process based on the user name 613 (T26), and then cause the display 13a to display a user name selection screen 51 shown in FIG. 10A (T27). The user name selection screen 51 is configured to display thereon a user selection field 511, a “Next” button 512, and an “Exit” button 513.

In the first illustrative embodiment, the customer database 6 of the customer management server 5 stores the user name 613 of each user in association with the device ID 311 of a corresponding device. Therefore, the auxiliary programs 42 obtain the device ID 311 from the printer 2 and send the obtained device ID 311 to the customer management server 5, thereby obtaining the user name applicable to the printer 2 from the customer management server 5. Thus, the auxiliary programs 42 display the user name applicable to the printer 2 in the user selection field 511.

After selecting one of the user names displayed in the user selection field 511 via the user I/F 13, the user clicks the “Next” button 512 and then enters a password on a next password entry screen (not shown). Thereafter, when the user has clicked a “Next” button via the user I/F13 (T28), the auxiliary programs 42 send the user name selected on the user name selection screen 51 (see FIG. 10A) and the password together with the device ID 311 of the printer 2 obtained in T18 to the customer management server 5 to request service information (T29). Namely, the auxiliary programs 42 log in to the customer management server 5 with the selected user name and the password to request the service information. On the user name selection screen 51 shown in FIG. 10A, “User 1,” “Administrator,” and “New User(s)” are displayed as selectable user names in the user selection field 511. In the following description, it is assumed that the user has selected “Administrator” as the user name.

Thus, in the first illustrative embodiment, by obtaining the account information (i.e., the user name 613 applicable to the printer 2) from the customer management server 5, it is possible to log in to the customer management server 5 using the user name 613, thereby saving the effort of the user to enter the user name and improving the convenience of logging in to the customer management server 5.

In response to receiving the request for the service information, the customer management server 5 checks, based on the device ID 311, whether the user name and the password sent by the PC 1 match the user name 613 and the password 614 in the customer database 6, respectively. If the user name and the password sent by the PC 1 are considered valid based on the user name 613 and the password 614 in the customer database 6, i.e., if the user name and the password sent by the PC 1 match the user name 613 and the password 614 in the customer database 6, respectively, the customer management server 5 extracts the rate plan 615, the application date 616, the additional plan information 617, and the addition date 618 that are associated with the user name (i.e., “Administrator”).

Further, the customer management server 5 sends the user name and the device ID 311 to the IoT server 7, and extracts, from the service record information 81 stored in the device database 8, the number of printed pages 813, the current number of printable pages 814, the initial number of printable pages 815, the remaining ink amount 816, and the activation information 817 that are associated with the user name (i.e., “Administrator”) and the device ID 311 (T30).

Thereafter, the customer management server 5 generates and stores service information corresponding to the user name sent by the PC 1 (T30). The service information includes the user name 613, the rate plan 615, the application date 616, the additional plan information 617, the addition date 618, the number of printed pages 813, the current number of printable pages 814, the initial number of printable pages 815, the remaining ink amount 816, and the activation information 817. The customer management server 5 sends the generated service information to the PC 1. Therefore, the auxiliary programs 42 obtain the service information (T31).

Thus, in the first illustrative embodiment, the user name used to log in to the customer management server 5 may be selected from among the plurality of user names. Therefore, it is possible to obtain the service information with conditions determined for each of the plurality of user names and to provide services suitable for each user.

Next, the auxiliary programs 42 perform a display process based on the obtained service information (T32), and cause the display 13a to display a menu screen 52 shown in FIG. 10B (T33). The menu screen 52 is configured to display thereon an “Add Rate Plan” button 521, an “Order Consumables” button 522, a “Reset Password” button 523, a “Usage History” button 524, and a “Back” button 525. In the first illustrative embodiment, the “Order Consumables” button 522 is displayed only when the auxiliary programs 42 log in to the customer management server 5 with “Administrator” selected as the user name on the user name selection screen 51 (see FIG. 10A), and is not displayed when the auxiliary programs 42 log in to the customer management server 5 with a general user name such as “User 1” or “New User.”

Thus, in the first illustrative embodiment, only the “Administrator” is allowed to place orders for consumables to be used in common by users, thereby preventing duplicate orders for consumables by individual users.

### Addition of Rate Plan

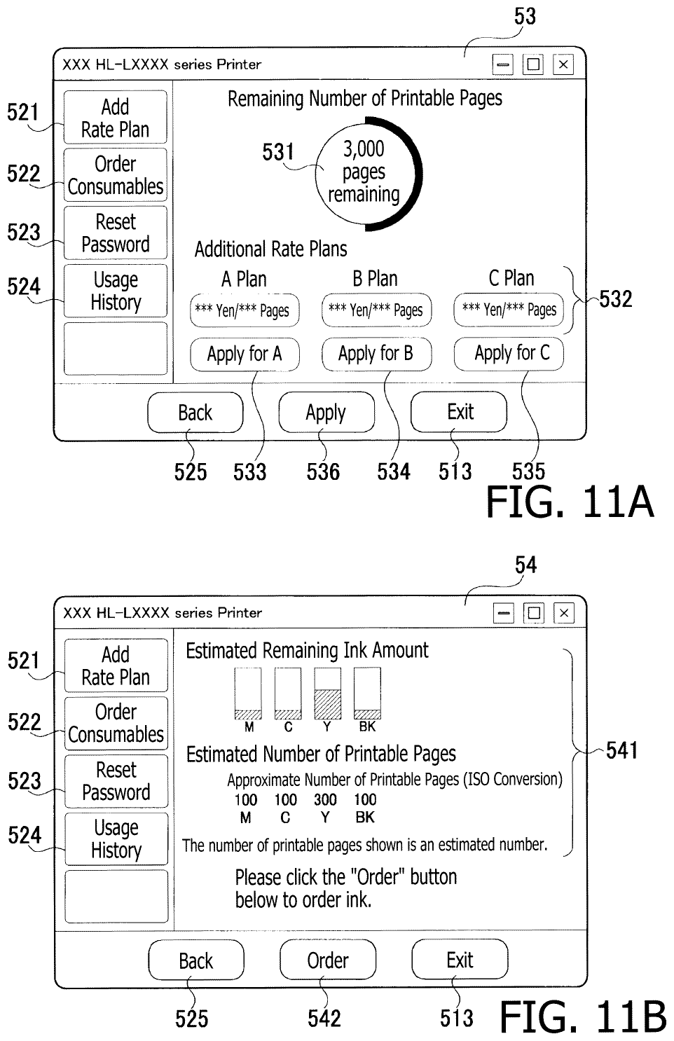

For instance, if the user clicks the “Add Rate Plan” button 521 via the user I/F 13, and then further clicks the “Next” button 512, the auxiliary programs 42 cause the display 13a to display a rate plan addition screen 53 shown in FIG. 11A. The rate plan addition screen 53 is configured to display thereon a number-of-printed-pages display field 531, an additional-rate-plans display field 532, an “Apply for A” button 533, an “Apply for B” button 534, an “Apply for C” button 535, and an “Apply” button 536. The number-of-printed-pages display field 531 is configured to show the initial number of printable pages 815 and the current number of printable pages 814 in a pie chart. In the additional-rate-plans display field 532, optional rate plans (i.e., an A plan, a B plan, and a C plan) are displayed that are selectable as an additional rate plan. The “Apply for A” button 533 is for applying for the A plan. The “Apply for B” button 534 is for applying for the B plan. The “Apply for C” button 535 is for applying for the C plan.

In the additional-rate-plans display field 532 of the rate plan addition screen 53, an additional number of printable pages and an additional fee are displayed for each of the A to C plans. The additional number of printable pages may be an example of “usage information” according to aspects of the present disclosure.

Thus, in the first illustrative embodiment, the auxiliary programs 42 obtain from the customer management server 5 the current number of printable pages 814 and the initial number of printable pages 815 corresponding to the user name (i.e., in this example, “Administrator”) selected by the user on the user name selection screen 51 (see FIG. 10A). The auxiliary programs 42 then cause the display 13a to display the number-of-printed-pages display field 531 based on the obtained current number of printable pages 814 and the obtained initial number of printable pages 815. This allows the user to accurately grasp the current usage status of the printing services by referring to the number-of-printed-pages display field 531 and to appropriately proceed with a procedure to add a rate plan.

When the user determines which plan to apply for among the A through C plans displayed in the additional-rate-plans display field 532 with reference to the current number of printable pages 814 (i.e., the remaining number of printable pages) displayed in the number-of-printed-pages display field 531, then clicks one of the “Apply for A” button 533, the “Apply for B” button 534, and the “Apply for C” button 535 via the user I/F 13, and thereafter further clicks the “Apply” button 536 (T34), the auxiliary programs 42 send additional rate plan information along with the device ID 311 of the printer 2 and the user ID to the customer management server 5 (T35).

In response to receiving the additional rate plan information, the device ID 311, and the user ID, the customer management server 5 updates the customer database 6 with respect to the additional plan information 617 and the addition date 618 based on the received additional rate plan information, the received device ID 311, and the received user ID (T36). In addition, the customer management server 5 sends the additional rate plan information, the device ID 311, and the user ID to the IoT server 7. The IoT server 7 then updates the current number of printable pages 814 and the initial number of printable pages 815 in the device database 8 based on the received additional rate plan information, the received device ID 311, and the received user ID.

In addition, the customer management server 5, which has received the additional rate plan information, the device ID 311, and the user ID, performs a billing process with respect to the additional rate plan information using the payment system 9 based on the payment information 619 corresponding to the device ID 311 and the user ID.

Thus, in the first illustrative embodiment, by clicking the “Start Application” button 172, the user is allowed to log in to the customer management server 5 without entering access information (e.g., the URL) for accessing the customer management server 5, thereby completing the procedure to add a rate plan and the billing process for the additional rate plan. Therefore, it is possible to simplify a procedure to change the conditions for using the printing services and to improve the convenience of using the printing services.

In addition, the auxiliary programs 42 send the additional rate plan information together with the user ID to the printer 2 (T37). Then, the printer 2, which has received the additional rate plan information together with the user ID, updates the current number of printable pages 315 and the initial number of printable pages 316 in the various types of information 31 stored in the printer storage 29, based on the received additional rate plan information and the received user ID (T38).

### Ordering Consumables

When the user has clicked the “Order Consumables” button 522 via the user I/F 13 while the menu screen 52 (see FIG. 10B) is being displayed on the display 13a (T33), the auxiliary programs 42 accept an instruction corresponding to the “Order Consumables” button 522 and cause the display 13a to display a consumable ordering screen 54 shown in FIG. 11B. The consumable ordering screen 54 is configured to display thereon a consumable information display field 541 and an “Order” button 542. In the consumable information display field 541, an estimated remaining ink amount and an estimated number of printable pages are displayed based on the remaining ink amount 816 included in the service information.

Thus, in the first illustrative embodiment, the auxiliary programs 42 cause the display 13a to display the consumable information display field 541 to display the estimated remaining ink amount and the estimated number of printable pages based on the remaining ink amount 816 included in the service information. This allows the user to accurately grasp a current consumption status of the consumables by referring to the consumable information display field 541, and to appropriately proceed with a procedure for ordering consumables.

When the user has clicked the “Order” button 542 via the user I/F 13 (T34), the auxiliary programs 42 send consumable order information together with the device ID 311 of the printer 2 and the user ID to the customer management server 5 (T35).

In response to receiving the consumable order information, the customer management server 5 updates the customer database 6 with respect to the additional plan information 617 and the addition date 618 based on the additional rate plan information, the device ID 311, and the user ID (T51). In addition, the customer management server 5 makes shipping arrangements for consumables. Among the various types of information 31 stored in the printer storage 29, the remaining ink amount 317 is updated when ink tanks (not shown) delivered by the vendor are set in the printer 2. In the first illustrative embodiment, the four types of ink (magenta M, cyan C, yellow Y, and black BK) are ordered together. However, each color of ink may be ordered separately. When the consumables are ordered for a fee, the customer management server 5 performs the billing process using the payment system 9 based on the payment information 619 in the customer contract information 61 stored in the customer database 6.

### Usage History

When the user has clicked the “Usage History” button 524 via the user I/F 13 while the menu screen 52 (see FIG. 10B) is being displayed on the display 13a (T33), the auxiliary programs 42 cause the display 13a to display a usage history screen (not shown). The usage history screen (not shown) is configured to display thereon the user's usage history based on the rate plan 615, the application date 616, the additional plan information 617, and the addition date 618 in the customer contract information 61 stored in the customer database 6.

In addition, the service record information 81 in the device database 8 connected with the IoT server 7 may include a print date in addition to the number of printed pages 813. In this case, a print history may be displayed on the usage history screen. Namely, if the auxiliary programs 42 obtain the service information including the number of printed pages 314 and the print date in T31, the auxiliary programs 42 may cause the display 13a to display the print history as well.

### Registration of New User

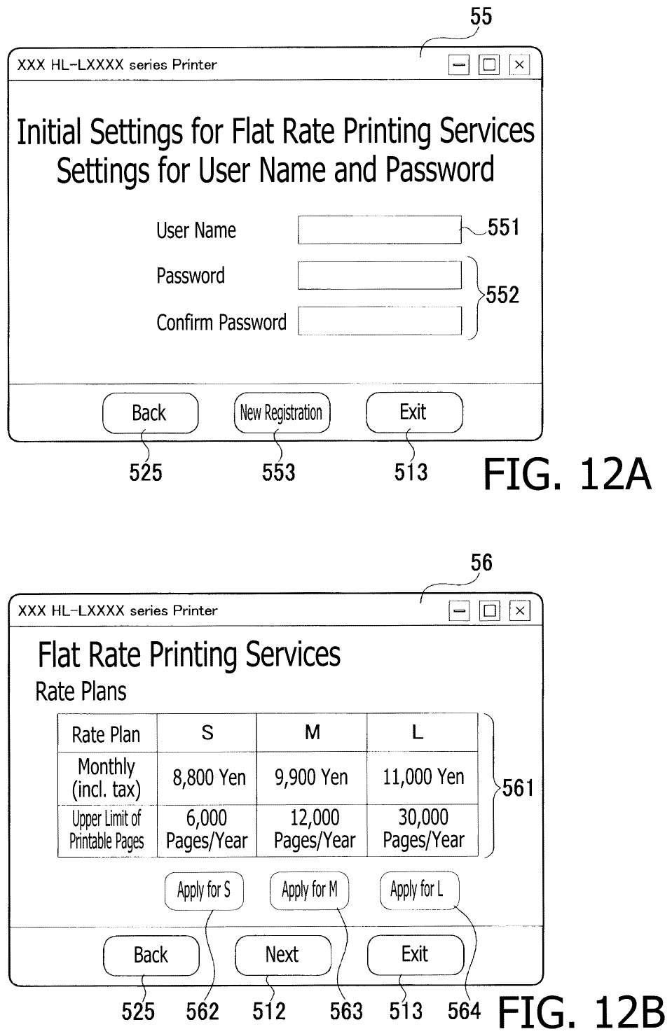

Next, when the user has selected “New User” displayed in the user selection field 511 while the user name selection screen 51 (see FIG. 10A) is being displayed on the display 13a (T27), the auxiliary programs 42 cause the display 13a to display a password setting screen 55 shown in FIG. 12A. The password setting screen 55 is configured to display thereon a user name entry field 551, a password entry field 552, and a “New Registration” button 553.

Here, when the user has entered a user name and a password in the user name entry field 551 and the password entry field 552, respectively, and then has further clicked the “New Registration” button 553 via the user I/F 13 (T28), the auxiliary programs 42 send the user name and the password entered on the password setting screen 55, together with the device ID 311 of the printer 2 obtained in T18, to the customer management server 5, thereby requesting service information for the new registration (T29).

In response to receiving the request for service information for the new registration, the customer management server 5 stores, as information of a new user, the user name and the password sent by the PC 1 in the user name 613 and the password 614 of the customer database 6, respectively, based on the device ID 311. Then, the customer management server 5 sends service information including initial setting information to the PC 1 (T31).

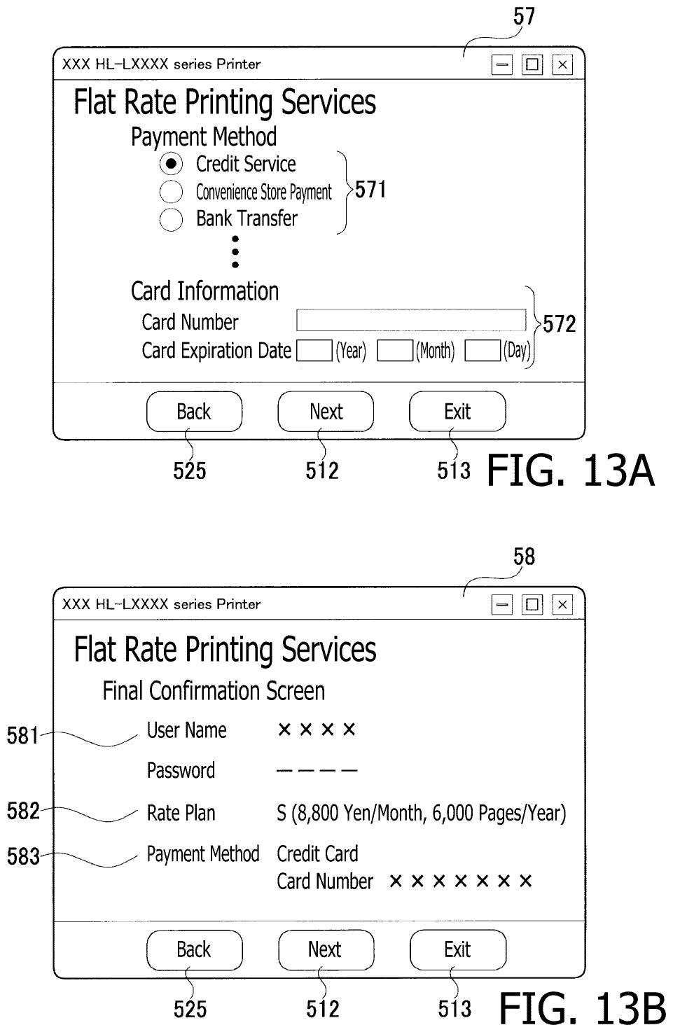

In response to receiving the service information including the initial setting information, the auxiliary programs 42 cause the display 13a to display a rate plan selection screen 56 shown in FIG. 12B based on the initial setting information included in the service information (T33). The rate plan selection screen 56 is configured to display thereon a plurality of rate plans 561, and “Apply” buttons 562 to 564 each of which is for applying for a corresponding one of the plurality of rate plans 561 as displayed. Here, for instance, when the user has clicked an “Apply for S” button 562 among the “Apply” buttons 562 to 564 via the user I/F 13, and then clicked the “Next” button 512 via the user I/F 13, the auxiliary programs 42 cause the display 13a to display a payment method selection screen 57 shown in FIG. 13A.

On the payment method selection screen 57 shown in FIG. 13A, a payment method selection field 571 is displayed. In the first illustrative embodiment, as shown in FIG. 13A, credit service is selected as a payment method. Accordingly, the auxiliary programs 42 cause the display 13a to display a card information entry field 572 below the payment method selection field 571 on the payment method selection screen 57. When the user has entered particular information in the card information entry field 572, and then has clicked the “Next” button 512 via the user I/F 13, the auxiliary programs 42 cause the display 13a to display a final confirmation screen 58 shown in FIG. 13B.

As shown in FIG. 13B, the final confirmation screen 58 is configured to display thereon a user name 581, a rate plan 582, and a payment method 583. When the user, after confirming the user name 581, the rate plan 582, and the payment method 583, clicks the “Apply” button 536 via the user I/F 13 to provide an instruction to apply for the specified rate plan (T34), the auxiliary programs 42 send the initial setting information including the device ID 311 to the customer management server 5 (T35).

In response to receiving the initial setting information including the device TD 311, the customer management server 5 stores the password 614, the rate plan 615, the application date 616, and the payment information 619 in the customer database based on the device ID 311 and user name (T36). Further, the customer management server 5 performs the billing process using the payment system 9 based on the payment information 619.

The auxiliary programs 42 send, to the printer 2, information on the initial number of printable pages along with the user name, based on the rate plan applied for by the user (T37). The printer 2, which has received the information on the initial number of printable pages together with the user name, stores the received information on the initial number of printable pages in the printer storage 29 as the initial number of printable pages 316, based on the user name (T38).

Thus, in the first illustrative embodiment, the user may select “New User,” which makes it possible to download the service information (i.e., the initial setting information) suitable for the new user from the customer management server 5. Therefore, a wide range of users, including new users, are allowed to use the printing services in the first illustrative embodiment.

### Execution of Printing

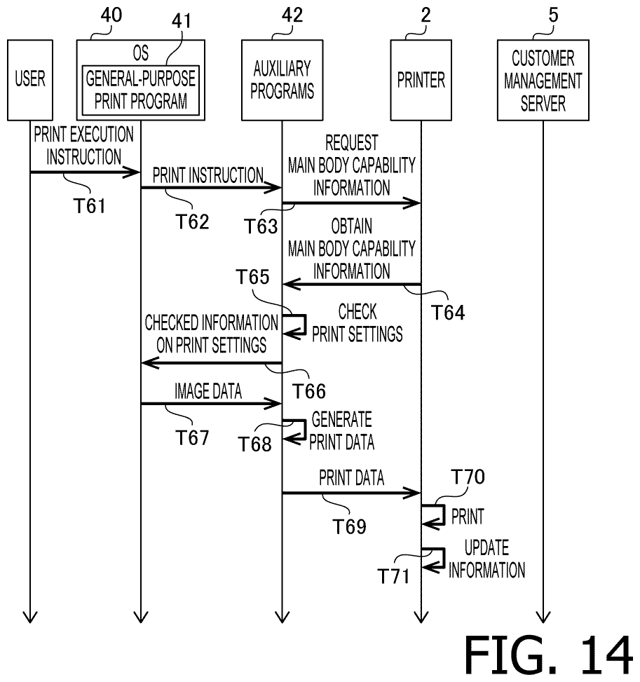

Subsequently, an explanation will be provided of a procedure of operations and processes by the individual programs in response to acceptance of a user operation to provide a print execution instruction, with reference to a sequence diagram shown in FIG. 14. The print execution instruction from the user may be input directly to the general-purpose print program 41, or may be input to the browser 43 or an application 44 and then output from the browser 43 or the application 44 to the general-purpose print program 41.

In response to the print execution instruction from the user (T61), the general-purpose print program 41 activates the auxiliary programs 42 and sends a request for processing corresponding to the print execution instruction to the auxiliary programs 42 (T62). In T62, the auxiliary programs 42 receive from the general-purpose print program 41 information on the print settings that were configured when the general-purpose print program 41 received the print execution instruction. Further, in T62, the general-purpose print program 41 may pass image data representing an image to be printed to the auxiliary programs 42.

In response to receiving a print instruction (T62), the auxiliary programs 42 send a request for information on main body capabilities (hereinafter, which may be referred to as “main body capability information”) to the printer 2 (T63). At this time, the auxiliary programs 42 also pass the user name of the user who has instructed printing to the printer 2. Based on the user name 312, the printer 2 extracts the activation information 318 from the various types of information 31 stored in the printer storage 29. The printer 2 then sends the extracted activation information 318 to the PC 1 together with the main body capability information. Accordingly, the auxiliary programs 42 obtain the main body capability information from the printer 2 (T64). The main body capability information includes, for instance, information on image processing executable by the printer 2.

Next, the auxiliary programs 42 check the information on the print settings received in T62 based on the obtained main body capability information (T65). In T65, the auxiliary programs 42 check, for instance, whether there is any discrepancy between the print settings and the main body capabilities of the printer 2. The auxiliary programs 42 also check whether the activation information 318 is in the “ON” state.

Next, the auxiliary programs 42 passes the checked information on the print settings to the general-purpose print program 41 when the activation information 318 is in the “ON” state (T66). When the activation information 318 is in the “OFF” state, the auxiliary programs 42 cause the display 13a to display an error message, and stop printing. Namely, when the activation information 318 is in the “OFF” state, the auxiliary programs 42 send an instruction to cancel a procedure for printing to the general-purpose print program 41.

The auxiliary programs 42 may change the print settings and pass the changed print settings in T66 according to results of the checking in T65. For instance, if the print settings received in T62 include information on particular image processing that is preferred to be performed by the printer 2 rather than by general-purpose print program 41 or the auxiliary programs 42, the auxiliary programs 42 may change the received print settings to settings from which the particular image processing is excluded. In such a case, the auxiliary programs 42 may store the information on the changed print settings (i.e., the print settings from which the particular image processing is excluded), thereby enabling the auxiliary programs 42 to pass the information on the changed print settings to the printer 2 in a later step. In this case, the auxiliary programs 42 may pass the information on the changed print settings to the general-purpose print program 41 in T66.

When the activation information 318 is in the “ON” state, the general-purpose print program 41 generates intermediate image data by converting a format of image data representing a target image to be printed into a format of intermediate image data using the print settings received from the auxiliary programs 42, and then passes the generated intermediate image data to the auxiliary programs 42 (T67). The applications 44 include various types of image data. The general-purpose print program 41 converts the image data to be printed into intermediate image data suitable for generating print data. If the image data to be printed is suitable for generating print data, generating the intermediate image data may be omitted. In this case, the image data to be printed may be used as intermediate image data. The intermediate image data is, for instance, XPS data.

The auxiliary programs 42 perform rasterization based on the intermediate image data received in T67 and generate print data representing the target image to be printed (T68). The print data generated in T68 is data in a format usable for printing by the printer 2, for instance, PDL data specific to the model of the printer 2.

When the processed intermediate image data is rasterized by the auxiliary programs 42 compatible with the printer 2, the rasterization is achieved with a higher degree of freedom and it is more likely that print data suitable for printing by the printer 2 is generated than when rasterized by the general-purpose print program 41. The print data generated by the auxiliary programs 42 may be in a format usable for printing by printers other than the model of the printer 2.

The auxiliary programs 42 transmit the print data generated in T68 to the printer 2 together with a print command for instructing the printer 2 to perform printing (T69). When there is image processing that has been determined in T65 to be performed by the printer 2, the auxiliary programs 42 generate a print command that includes information on the image processing. The auxiliary programs 42 may further provide a notification that the transmission of the print data has been completed to the general-purpose print program 41.

The printer 2, which has received the print data and the print command, performs printing of the target image represented by the print data based on the received print command (T70). Thus, a printed material is generated.

Instead of the auxiliary programs 42 generating the print data, the general-purpose print program 41 may generate the print data. For instance, the auxiliary programs 42 may pass the intermediate image data received in T67 and information on printing to be executed to the general-purpose print program 41. Then, the general-purpose print program 41 may rasterize the processed intermediate image data to generate the print data. In this case, the general-purpose print program 41 may pass the generated print data to the auxiliary programs 42. In response to receiving the print data from the general-purpose print program 41, the auxiliary programs 42 send the received print data to the printer 2 together with the print command for instructing the printer to perform printing.

The print data generated by the general-purpose print program 41 is print data (e.g., PWG Raster data or PDF data) in a format usable for printing by various types of printers. If rasterization is performed by the general-purpose print program 41, it results in a smaller amount of processing by the auxiliary programs 42, thereby avoiding an increase in processing time, and reducing a program size of the auxiliary programs 42.

The general-purpose print program 41 may send the print data and the print command to the printer 2. Namely, the auxiliary programs 42 may pass the generated print data to the general-purpose print program 41, to be sent from the PC 1 with the printer 2 as a destination. In this case, the general-purpose print program 41 may send to the printer 2 the print data received from the auxiliary programs 42.

When the printer 2 has completed printing, the printer 2 updates the various types of information 31 stored in the printer storage 29 (T71). For instance, the value of the number of printed pages 314 is incremented by the number of pages printed. Meanwhile, the value of the current number of printable pages 315 is decremented by the number of pages printed. When the value of the current number of printable pages 315 becomes “zero” or negative as a result of the decrement, the printer 2 rewrites the activation information 318 in the “ON” state to be in the “OFF” state. Therefore, this user is no longer allowed to print with the printer 2.

In this case, the printer 2 may pass the activation information 318 in the “OFF” state to the general-purpose print program 41. Additionally, in this case, the general-purpose print program 41 may cause the display 13a to display an error message, as well as a message for prompting the user to add a further rate plan for the printing services.

In addition, after printing is completed, the printer 2 sends the number of printed pages 314, the current number of printable pages 315, and the activation information 318 to the IoT server 7. In response to receiving the number of printed pages 314, the current number of printable pages 315, and the activation information 318, the IoT server 7 updates the number of printed pages 813, the current number of printable pages 814, and the activation information 817 in the device database 8.

Thus, in the first illustrative embodiment, the auxiliary programs 42 obtain the activation information 318 from the printer 2 in T64. This makes it possible to obtain the activation information 318 more quickly without involving the Internet 300 and perform printing more smoothly, than when the activation information 318 is obtained from the IoT server 7.

### Second Illustrative Embodiment

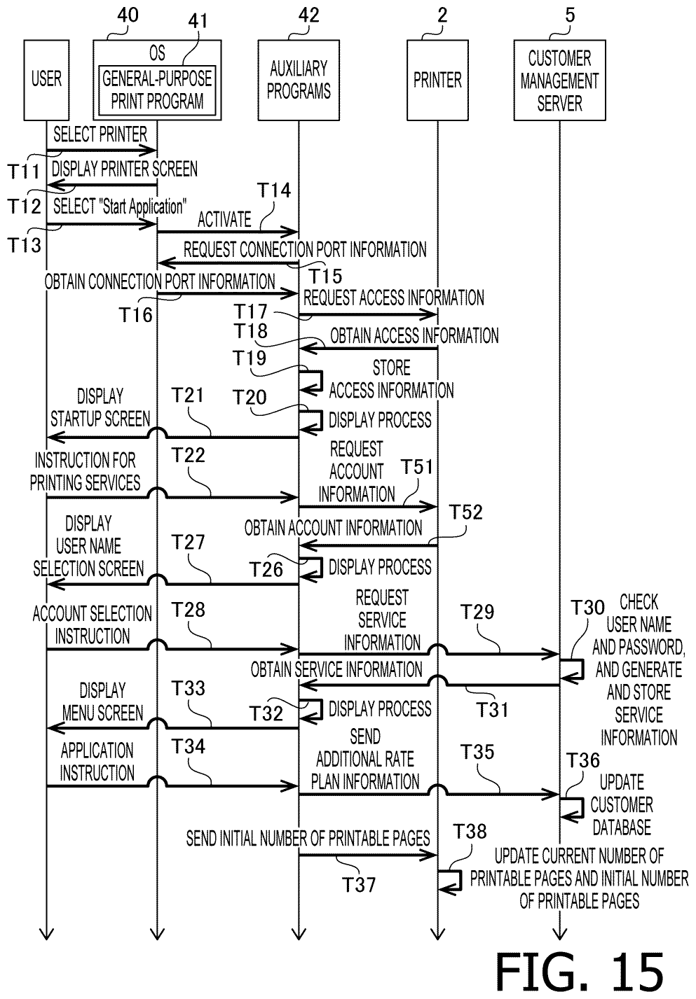

Subsequently, with reference to a sequence diagram shown in FIG. 15, an explanation will be provided of an example procedure of a printing service process provided to the user by the auxiliary programs 42, which includes operations and processes by the OS 40, the printer 2, and the customer management server 5, in a second illustrative embodiment according to aspects of the present disclosure. In the explanation, the same reference characters are assigned to substantially the same processes as those in the aforementioned first illustrative embodiment.

In the aforementioned first illustrative embodiment, the auxiliary programs 42 obtain the account information from the customer management server 5 in T25 (see FIG. 6). However, in the second illustrative embodiment, the auxiliary programs 42 obtain the account information from the printer 2.

In FIG. 15, the auxiliary programs 42 access the printer 2 based on the connection port information obtained in T16 and sends a request for the account information (T51).

In response to receiving the request for the account information, the printer 2 extracts the user name 312 from the various types of information 31 stored in the printer storage 29 of the printer 2, and sends the extracted user name 312 to the PC 1 (T52).

In response to receiving the user name 312, the auxiliary programs 42 perform the display process (T26) based on the received user name 312, and then cause the display 13a to display the user name selection screen 51 shown in FIG. 10A (T27).

In the second illustrative embodiment, in the case of such a configuration that the startup screen 18 (see FIG. 9) does not need to be displayed on the display 13a, i.e., the user name selection screen 51 (see FIG. 10A) is immediately displayed on the display 13a in response to a click operation on the “Start Application” button 172 on the printer screen 17 (see FIG. 8), the auxiliary programs 42 may obtain the access information and the user name 312 in T18. Then, based on the obtained user name 312, the auxiliary programs 42 may cause the display 13a to display the user name selection screen 51 shown in FIG. 10A.

As described in detail above, in the second illustrative embodiment, when the OS 40 has accepted a start instruction to activate the auxiliary programs 42, i.e., when the user has clicked the “Start Application” button 172 on the printer screen 17 (see FIG. 8) via the user I/F 13, the auxiliary programs 42 obtain connection information (e.g., the connection port information) of the printer 2 from the OS 40, obtain the access information from the printer 2 using the obtained connection information, and access the customer management server 5 using the obtained access information, thereby obtaining the service information including the initial setting information. Thus, the user is allowed to view the service information regarding the services providable by the customer management server 5, only by performing an operation to input the start instruction, without having to inputting access information for accessing the customer management server 5, and without having to perform an operation to activate an application 44 for displaying the service information. Thus, it is possible to improve the convenience of viewing the service information.

While aspects of the present disclosure have been described in conjunction with various example structures outlined above and illustrated in the drawings, various alternatives, modifications, variations, improvements, and/or substantial equivalents, whether known or that may be presently unforeseen, may become apparent to those having at least ordinary skill in the art. Accordingly, the example embodiment(s), as set forth above, are intended to be illustrative of the technical concepts according to aspects of the present disclosure, and not limiting the technical concepts. Various changes may be made without departing from the spirit and scope of the technical concepts according to aspects of the present disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

For instance, the device connected with the PC 1 is not limited to printer 2, but may be any device (e.g., multi-function peripherals, copiers, and fax machines) having a printing function. The number of printers 2 connected with the PC 1 is not limited to the example (i.e., one) shown in the relevant drawings, but may be two or more.

In the aforementioned illustrative embodiments, the PC 1 is configured by a notebook type personal computer. However, the PC 1 may be configured by a desktop type personal computer. In this case, the PC 1 may have interfaces connectable with devices (specifically, for instance, a keyboard, a mouse, and a display) that implement the functions of the user I/F 13. In another instance, the PC 1 may be configured by a smartphone or a tablet computer.

In the aforementioned illustrative embodiments, examples of the usage conditions (e.g., the usage information) for using the printing services provided by the vendor to the user may include, but are not limited to, the number of pages that the user is allowed to print with the printer 2, and consumables. Examples of the usage conditions may further include a usage period during which the user is allowed to use the printer 2, and functional restrictions of the printer 2. Examples of the functional restrictions of the printer 2 may include, but are not limited to, a restriction that only simplex printing is available and duplex printing is not available, a restriction that limited types of trays are usable, and a restriction that only monochrome printing is available and color printing is not available.

In the aforementioned illustrative embodiments, the auxiliary programs 42 are configured to access the customer management server 5 to directly obtain service information. However, practicable examples are not limited thereto. For instance, the auxiliary programs 42 may be configured to request the printer 2 to obtain the service information, thereby causing the printer 2 to access the customer management server 5 to obtain the service information. In this case, the auxiliary programs 42 may further be configured to obtain the service information obtained by the printer 2 indirectly from the printer 2.

In the aforementioned illustrative embodiments, the printer 2 is configured to update the activation information 318 when printing has been completed. However, the IoT server 7 may be configured to update the activation information 318 when printing has been completed. Namely, in response to receiving the value of the number of printed pages 314, the IoT server 7 may decrement the value of the current number of printable pages 814 by the number of printed pages. When the value of the current number of printable pages 814 as decremented becomes “zero” or negative, the IoT server 7 may rewrite the activation information 817 in the “ON” state to be in the “OFF” state.

In this case, only the device ID 311 may be stored as the various types of information 31 of the printer 2. In this case, the auxiliary programs 42 are required to send a request for the activation information 817 to the IoT server 7 and to obtain the activation information 817 from the IoT server 7 in T63 to T64.

In the aforementioned illustrative embodiments, the customer management server 5 is configured to perform a checking process to check whether the user name and the password sent by the PC 1 match the user name 613 and the password 614 in the customer database 6 based on the device ID 311 in T30. However, the auxiliary programs 42 may be configured to perform the checking process. Specifically, in T28, the user may enter a password after selecting one of the user names displayed in the user selection field 511. Then, when the user has clicked the “Next” button 512 via the user I/F 13, the auxiliary programs may check the selected user name and the entered password against the user name 312 and the password 313 in the various types of information 31 stored in the printer storage 29. If there are no problems as a result of the checking process, the auxiliary programs 42 may perform the process of T29. In this case, it is possible to notify the user of the checking result more promptly than when the customer management server 5 performs the checking process.

In the aforementioned illustrative embodiments, when the user has clicked the “Printing Services” button 181 via the user I/F 13 while the startup screen 18 (see FIG. 9) is being displayed on the display 13a (T22), the auxiliary programs 42 access the customer management server 5 to send a request for the account information based on the access information 30 obtained in T18 (T23), and also perform the subsequent processing. However, practicable examples are not limited thereto. In another instance, the auxiliary programs 42 may activate the browser 43 to access a page of the customer management server 5 based on the access information 30 obtained in T18. Thereby, the PC 1 may cause the customer management server 5 to perform the subsequent processing after T23 through the browser 43.

The auxiliary programs 42 may further have other roles. Examples of the program to perform the processing in the aforementioned illustrative embodiments are not limited to the auxiliary programs 42, but may include any program configured to accept instructions from the OS 40 or the general-purpose print program 41 when printing is performed using the general-purpose print program 41. For instance, a print workflow application (Print workflow) whose specifications have been published by Microsoft Corp. may be included in the examples of the program to perform the processing in the aforementioned illustrative embodiments.

Practicable examples of the execution timing for executing the auxiliary programs 42 are not limited to the examples in the aforementioned illustrative embodiments. For instance, the auxiliary programs 42 may be executed in response to a direct execution instruction from the OS 40. In another instance, the auxiliary programs 42 may be resident programs. In this case, the auxiliary programs 42 may perform the aforementioned operations in response to receiving execution commands.

In any flowchart disclosed in the aforementioned illustrative embodiments, a plurality of processes in a plurality of any steps may be arbitrarily changed in the execution order thereof or may be executed in parallel as long as there is no inconsistency in the processing results.

The processing disclosed in the aforementioned illustrative embodiments may be performed by one or more CPUs, one or more hardware elements such as ASICs, or a combination of at least two selected therefrom. The processing disclosed in the aforementioned illustrative embodiments may be implemented in various aspects such as a non-transitory computer-readable storage medium storing computer-readable instructions (e.g., programs) for performing the processing, or a method for performing the processing.

The following shows examples of associations between elements illustrated in the aforementioned illustrative embodiment(s) and modification(s), and elements claimed according to aspects of the present disclosure. For instance, the PC 1 may be an example of an “information processing device” according to aspects of the present disclosure. The CPU 11 may be an example of a “computer” according to aspects of the present disclosure. The controller 10 may be an example of a “controller” according to aspects of the present disclosure. The memory 12 may be an example of a “non-transitory computer-readable storage medium” according to aspects of the present disclosure, and may be an example of a “memory” according to aspects of the present disclosure. The display 13a may be an example of a “display” according to aspects of the present disclosure. The auxiliary programs 42 may be an example of a “support program” according to aspects of the present disclosure. The general-purpose print program 41 may be an example of a “general-purpose print program” according to aspects of the present disclosure. The applications 44 may be included in examples of an “application program” according to aspects of the present disclosure. The printer 2 may be an example of a “particular printer” according to aspects of the present disclosure.

What is claimed is:

1. A non-transitory computer-readable storage medium storing computer-readable instructions that are executable by a computer of an information processing device and compatible with a particular printer, the computer-readable instructions realizing a support program supporting a general-purpose print program incorporated in advance in an operating system of the information processing device, the support program being configured to, when executed by the computer, cause the information processing device to:
in response to receiving a request for processing from the general-purpose print program of the operating system when the operating system has accepted an activation instruction to activate the support program compatible with the particular printer with the particular printer selected, obtain access information from the particular printer using connection information, the access information being used to access a server, the connection information indicating a connection destination to which the particular printer is connected;
obtain service information from the server using the obtained access information, the service information being information regarding a service provided by the server and applied to the particular printer; and
display information based on the obtained service information.

2. The non-transitory computer-readable storage medium according to claim 1,
wherein the support program is further configured to, when executed by the computer, cause the information processing device to:
access the server using the obtained access information, and obtain account information used to log in to the server from the server, thereby obtaining, using the obtained account information, the service information associated with the account information from the server.

3. The non-transitory computer-readable storage medium according to claim 2,
wherein the support program is further configured to, when executed by the computer, cause the information processing device to:
when the account information obtained from the server includes a plurality of pieces of account information, accept a selection of one piece of account information used to log in to the server from the plurality of pieces of account information, and obtain from the server the service information associated with the selected one piece of account information.

4. The non-transitory computer-readable storage medium according to claim 2,
wherein the support program is further configured to, when executed by the computer, cause the information processing device to:
after displaying the information based on the obtained service information, accept an input regarding the service; and
in response to accepting the input regarding the service, send to the server a request command to perform a particular process to update the service information, in association with the obtained account information, thereby causing the server to, in response to receiving the request command, perform the particular process corresponding to the request command, and update the service information associated with the account information.

5. The non-transitory computer-readable storage medium according to claim 4,
wherein the support program is further configured to, when executed by the computer, cause the information processing device to:
after displaying the information based on the obtained service information, accept an input regarding payment for using the service as the input regarding the service, the service information including payment information regarding the payment for using the service; and
in response to accepting the input regarding the payment for using the service, send to the server the request command to perform the particular process, in association with the obtained account information, thereby causing the server to, in response to receiving the request command, perform the particular process corresponding to the request command, and update the payment information included in the service information associated with the account information.

6. The non-transitory computer-readable storage medium according to claim 4,
wherein the support program is further configured to, when executed by the computer, cause the information processing device to:
after displaying the information based on the obtained service information, accept an input regarding a condition for using the service as the input regarding the service, the service information including condition information regarding the condition for using the service; and
in response to accepting the input regarding the condition for using the service, send to the server the request command to perform the particular process, in association with the obtained account information, thereby causing the server to, in response to receiving the request command, perform the particular process corresponding to the request command, and update the condition information included in the service information associated with the account information.

7. The non-transitory computer-readable storage medium according to claim 4,
wherein the support program is further configured to, when executed by the computer, cause the information processing device to:
after displaying the information based on the obtained service information, accept an input regarding consumables used for the service as the input regarding the service, the service information including consumable information regarding the consumables used for the service; and
in response to accepting the input regarding the consumables used for the service, send to the server the request command to perform the particular process, in association with the obtained account information, thereby causing the server to, in response to receiving the request command, perform the particular process corresponding to the request command, and update the consumable information included in the service information associated with the account information.

8. The non-transitory computer-readable storage medium according to claim 2,
wherein the support program is further configured to, when executed by the computer, cause the information processing device to:
after accessing the server using the obtained access information and obtaining the account information from the server, accept a selection of one piece of account information from the obtained account information and new account information;
in response to accepting a selection of one piece of account information from the obtained account information, obtain from the server the service information associated with the selected one piece of account information; and
in response to accepting a selection of new account information, send a generation command to generate new account information to the server, and obtain from the server the service information associated with the generated new account information.

9. The non-transitory computer-readable storage medium according to claim 1,
wherein the support program is further configured to, when executed by the computer, cause the information processing device to:
in response to receiving a processing request from the general-purpose print program of the operating system when a print instruction to cause the particular printer to print a target image has been output from an application program incorporated in the information processing device to the general-purpose print program, obtain image data representing the target image from the general-purpose print program, and send a print command based on the obtained image data to the particular printer.

10. An information processing device comprising:
a display; and
a controller comprising:
a computer; and
a non-transitory computer-readable storage medium storing a general-purpose print program incorporated in advance in an operating system of the information processing device, and computer-readable instructions realizing a support program that is compatible with a particular printer and supports the general-purpose print program, the support program being configured to, when executed by the computer, cause the controller to:
in response to receiving a request for processing from the general-purpose print program of the operating system when the operating system has accepted an activation instruction to activate the support program compatible with the particular printer with the particular printer selected, obtain access information from the particular printer using connection information, the access information being used to access a server, the connection information indicating a connection destination to which the particular printer is connected;
obtain service information from the server using the obtained access information, the service information being information regarding a service provided by the server and applied to the particular printer; and
display information based on the obtained service information on the display.

11. A method implementable by a computer executing computer-readable instructions on an information processing device, the computer-readable instructions being compatible with a particular printer and realizing a support program supporting a general-purpose print program incorporated in advance in an operating system of the information processing device, the method comprising:
in response to receiving a request for processing from the general-purpose print program of the operating system when the operating system has accepted an activation instruction to activate the support program compatible with the particular printer with the particular printer selected, obtaining, by the support program, access information from the particular printer using connection information, the access information being used to access a server, the connection information indicating a connection destination to which the particular printer is connected;
obtaining, by the support program, service information from the server using the obtained access information, the service information being information regarding a service provided by the server and applied to the particular printer; and
displaying, by the support program, information based on the obtained service information.
